(19) United States
(12) Patent Application Publication
(10) Pub. No.: US 2024/0351048 A1
(43) Pub. Date: Oct. 24, 2024

(54) AIR PURIFIER DEVICE

(71) Applicant: AÉROGROUPE, Paris (FR)

(72) Inventors: Jérôme Giacomoni, Saint Cloud (FR); Mathieu Gobbi, Paris (FR)

(73) Assignee: AÉROGROUPE, Paris (FR)

(21) Appl. No.: 18/701,111

(22) PCT Filed: Sep. 29, 2022
(86) PCT No.: PCT/EP2022/077098

§ 371 Date: Apr. 12, 2024

(30) Foreign Application Priority Data
Oct. 12, 2021 (FR) FR2110777

(51) Int. Cl. B03C 3/12; B01D 53/88; B03C 3/017; B03C 3/32; B03C 3/36; B03C 3/38; B03C 3/41; B03C 3/47

(52) U.S. Cl. CPC B03C 3/12; B01D 53/885; B03C 3/0175; B03C 3/32; B03C 3/363; B03C 3/365; B03C 3/368; B03C 3/38; B03C 3/41; B03C 3/47; B01D 2255/20707; B01D 2255/802; B01D 2258/06; B03C 2201/30

(57) ABSTRACT

An air purifier device is disclosed. The device includes at least one first collector, an ionizing device configured to ionize fine particles in the air, an agglomeration chamber configured to aggregate the ionized fine particles, and a frame configured to enclose the ionizing device, agglomeration chamber, and first collector. The first collector includes a non-insulating material first surface of a size greater than 1 square meter, a non-insulating material first reference surface, and a first electric generator configured to apply to the first surface a potential relative to the reference surface between 5 kV and 500 kV. The at least one first collector is configured to collect at least some of the aggregates of the fine particles. The ionizing device includes multiple spikes, a grating, and an electric generator configured to apply to the spikes a predetermined potential relative to the grating of at least 100 kV/m.

### TECHNICAL FIELD OF THE INVENTION

The invention concerns an air purifier device and more precisely a device capable of destroying fine particles present in the air. A device of this kind is intended to depollute the air in an area to be depolluted, in particular an area situated outdoors.

PRIOR ART

The combustion of fuels leads in particular to the emission of fine and ultrafine particles.

These particles, the low average weight of which causes them to remain in suspension in the air, represents a major public health problem. In the metrology of particulate matter (PM) a distinction is made according to the size of the particles, in particular between “PM10”, “PM2.5” or “PM1” fine particles with diameters respectively less than 10 μm, 2.5 μm or 1 μm. Particles with a diameter of less than 0.1 μm are classified as “ultrafine particles”.

Surveillance of air quality employs very sophisticated physical methods of detecting fine and ultrafine polluting particles, involving for example the use of quartz microbalances, beta ray probes or optical counting processes employing laser diffraction sensors.

Some devices that are commercially available ionize fine particles in suspension to purify the air in confined surroundings such as inside an inhabited room. Said ionized particles then agglomerate and the agglomerates, of greater weight, fall to the floor or become attached to the walls of the room by an electrostatic effect, where they can be stored and collected.

At present depollution of the air outdoors consists mainly in limiting the emission of particles at source, for example by means of devices such as catalytic converters for vehicles, filters for area heating systems and for industrial heating systems, and waste incinerators.

The recent approach to depolluting outdoor air of fine and ultrafine particles, at least locally, consists in aspiration and filtering of fine and ultrafine particles in suspension in the air. The Dutch company Envinity® has made public the design of ultrapowerful aspirators containing filters taking the form of filter cartridges generally consisting of one or more layers of porous, fibrous or granular materials for filtering the air. Envinity aspirators should be capable of treating 800 000 m³ of air per hour and the company claims 95% filtration of PM and 90% filtration of ultrafine particles from the treated air [Ref. 1]. However, this approach consumes a great deal of energy as it causes a large volume of air to circulate through a small area. Moreover, changing and cleaning the filters generates high material and labor costs.

To depollute the air outdoors it is also known to use photocatalysts, such as titanium dioxide (TiO₂) for example. When activated by ultraviolet rays emitted by a natural or artificial source TiO₂ enables oxidation (by a photocatalysis reaction) of pollutants which are then converted into oxidation products CO₂ and H₂O. Photocatalysis is effected by means of a coating comprising the photocatalyst applied to external walls, for example in public places or near roads. This method enables destruction of odors and cleaning of the surfaces. However, this method is limited because it acts only on particles that come to be deposited on the treated surfaces naturally.

Recently the applicant has developed a device for local depollution of the air that uses the surface of the envelope of a captive balloon to capture and to transform fine particles into CO₂ and H₂O [Ref. 2]. The depollution device is based on the potential difference between the envelope of the balloon and the environment, this potential difference enabling fine particles to be attracted onto the envelope where they can be degraded, for example by means of a coating comprising titanium dioxide. However, in practise the applicant has demonstrated that the effect of the wind on the fine particles often proves to predominate over the electrical attraction, and so the fine particles tend to slide on the balloon when wind is present. Published patent application US 2013/025449 A1 [Ref. 3] moreover describes a device for capturing particles that can form part of an object (or be integrated into an object) including urban street furniture. The capture device includes a surface that can be charged and a generator adapted to generate a charge on the surface that can be charged and thus to generate a static electric field of at least 0.2 kV/m.

The document US 2020/376498 [Ref. 4] describes a bidirectional electrostatic filter system aimed at processing heavy pollution in factories and using an adjustable distance between a front (or rear) charging part and a part for collecting polluting particles.

The present application describes an air purifier device adapted to function for example outdoors and with low energy consumption, but which has an increased efficacy relative to the known prior art devices.

### SUMMARY OF THE INVENTION

In the present description “comprise” has the same meaning as “include” and “contain” and is inclusive or open and does not exclude other elements not described or represented. Further, in the present description the term “about” or “substantially” is synonymous with (means the same thing as) having a margin less than and/or greater than 10%, for example 5%, of the respective value.

In accordance with a first aspect, the present invention concerns an air purifier device, in particular an air purifier configured to extend in an area to be depolluted.

The air purifier device in accordance with the first aspect comprises at least one first collector comprising a non-insulating material first surface with an area greater than about 1 m², a non-insulating material first reference surface and a first electric generator configured to apply to said first surface a first potential relative to said reference surface between about 5 kV and about 500 KV so as to generate an electric field between said first surface and said reference surface greater than or equal to about 10 kV/m. In the remainder of the description the first reference surface and the first electric generator are more simply referred to as the reference surface and the electric generator.

The purifier device in accordance with the first aspect further comprises an ionizing device configured to ionize some of the fine particles present in the air, for example by the corona discharge. The ionizing device comprises a plurality of spikes, a grating and an electric generator configured to apply to said spikes of the plurality of spikes a predetermined potential relative to the grating so as to generate an electrical field between the plurality of spikes and the grating of at least 100 kV/m.

The space between the ionizing device and the first collector is called the agglomeration chamber in the present description. The agglomeration chamber is configured to aggregate at least some of the fine particles ionized by the ionizing device to form fine particle aggregates. The at least one first collector is thus configured to collect at least some of the fine particle aggregates. The at least one first collector can also collect at least some of the non-aggregated ionized fine particles and/or at least some of the fine particles, for example ionized fine particles.

The air purifier device in accordance with the first aspect further comprises a frame configured to enclose at least the ionizing device, the agglomeration chamber and the at least one first collector.

By non-insulating material is meant a conductive material or a material having a finite impedance, that is to say a material able to transmit completely or partially an electric potential. In the remainder of the description a non-insulating material will also be referred to as a finite electric impedance material. In one or more embodiments a non-insulating material of this kind is a material having a conductivity of at least 104 S/cm, for example at least 1 S/cm, for example at least 10 S/cm.

The non-insulating material may comprise a single material or a combination of different materials. For example, the non-insulating material constituting the first surface may comprise an additive, e.g. aluminum, rendering said material conductive or imparting to it a non-zero finite impedance. The first material may equally comprise a multilayer material. The applicant has demonstrated that it is therefore possible to trap fine particles present in the air of an area to be depolluted with increased efficacy compared to known devices.

The device in accordance with the first aspect has to this end a configuration with three successive stages: a first stage for ionizing fine particles, a second stage for aggregating ionized fine particles and a third stage for collecting at least some of the fine particle aggregates and non-aggregated particles, all of these elements being assembled inside a frame.

In the third stage, i.e. the collector, an intense electrical field of the order of 10 kV/m or greater is generated between the first surface and the reference surface. The fine particle aggregates coming from the second stage, i.e. the agglomeration chamber, and the non-aggregated particles are subjected to the influence of the electric field. Depending on the direction of the field and the sign of the electric charge on said aggregates and particles, said aggregates and particles are attracted either by the first surface or by the reference surface and are deposited on the first surface or the reference surface respectively.

The frame enclosing the three stages contributes to generating a flow of air and to channeling the flow of air through the three stages of the air purifier device.

The frame may be insulative, but in accordance with one or more embodiments, the frame comprises a non-insulating material, for example electrically connected to ground for safety. The applicant has demonstrated that a device in accordance with the first aspect of the present description is able to purify air without necessitating filter cartridges, which represents a definite advantage. In fact, a device in accordance with the first aspect consumes little energy compared to the ultrapowerful aspirators cited in the prior art, for example in [Ref. 1], the energy consumption of which is high in order to compensate the air resistance inherent to the presence of filter cartridges.

Compared to a device like that described in [Ref. 3] the original architecture with three independent stages formed of an ionizing device, an agglomeration chamber and at least one first collector assembled in a frame enables the efficacy of the air purifier device to be increased in particular because of the generation and the channeling of air that passes through the various stages. It is therefore possible to purify a greater quantity of air in a smaller volume.

In particular, in the device in accordance with the first aspect an electric field is generated between the plurality of spikes and the grating of the ionizing device, independently of the electric field generated between the first surface and the reference surface of the at least one first collector. The grating of the ionizing device therefore constitutes a counter-electrode enabling interdependence between the ionization stage and the collection stage to be avoided. In contrast to the device described in [Ref. 4] for example, an ionization stage independent of the collection stage is advantageous because in the context of optimized depollution it enables the influence of the parameters specific to one stage on those of another stage to be avoided. In one or more embodiments the electric generator is a direct current or alternating current generator.

Said first potential relative to the reference surface applied to the first surface is between about 5 kV and about 500 KV so as to generate an electric field between the two surfaces greater than or equal to about 10 kV/m. In accordance with one or more embodiments the first potential is between about 10 kV and about 500 kV, for example between about 30 kV and about 100 kV. In one or more embodiments the maximum distance separating the spike or spikes of said first surface nearest the reference surface is less than or equal to n/10 meters when the first potential =n kV, where n is a number between about 5 and about 500, for example. For example, when the first potential is equal to 5 kV, said maximum distance is equal to 0.5 m so as to generate an electric field between the two surfaces greater than or equal to about 10 kV/m.

The area of the first surface is greater than about 1 m². In one or more embodiments the area of the first surface is greater than about 5 m², for example greater than about 10 m², for example greater than about 20 m², for example greater than about 100 m². Such large surfaces can enable treatment of a large volume of air and a large quantity of fine particles when the device is deployed to depollute an area. In order for the weight of the device and the wind resistance not to become penalties and given the implementation cost of the device, lightweight materials may be preferred to constitute the first surface, such as permeable materials, such as thin and perforated sheets, nets, canvas and combinations thereof. In one or more embodiments the first surface comprises at least one flexible material, selected for example in the group comprising rubber, coated canvas, laminated canvas. In one or more embodiments the at least one flexible material comprises a textile, e.g. polyester, layer covered by an e.g. PVC or polyurethane film. In one or more embodiments the first surface comprises at least one rigid material, for example a metal, e.g. aluminum, or a metal alloy, e.g. stainless steel. In one or more embodiments the at least one rigid material is in the form of perforated rigid plates.

In one or more embodiments said first surface comprises a canvas and/or a net. A canvas in the sense of the present description is a two-dimensional array of strands that are meshed (that is to say arranged in accordance with substantially regular patterns), in which the average dimensions of the meshes are less than about 1 cm. A net in the sense of the present description is a two-dimensional array of strands. In one or more embodiments the net is meshed, the average dimensions of the meshes being for example greater than or equal to about 1 cm. For example, a net may consist of a knotted assembly of ropes and/or an array of metal wires welded together.

The reference surface is included in the at least one first collector of the air purifier device in accordance with the first aspect. In one or more embodiments said reference surface has one or more of the features cited above with reference to the first surface, for example in terms of composition, dimensions, shape. The reference surface is a non-insulating material surface. It may be configured to extend in said area to be depolluted. The reference surface may advantageously have a size greater than about 1 m².

In one or more embodiments the reference surface is electrically connected to ground and therefore at ground potential. The reference surface may be electrically connected to ground by means of an electrically conductive element. Alternatively, the reference surface may have applied to it a potential different from ground potential and the first potential so that the electric field between the two surfaces is greater than or equal to about 10 kV/m. In one or more embodiments the potentials on the first surface and on the reference surface are of opposite sign. Such a configuration of the air purifier device advantageously enables a high potential difference to be obtained between said first surface and said reference surface without the potentials of the two surfaces being too high. For example, the first surface may be at +50 kV and the reference surface at −50 kV so that the potential difference is 100 kV. In one or more embodiments the reference surface is a localized surface. By “localized surface” is meant in the present description a surface formed by an end of at least one strand or of at least one cable or of at least one spike and combinations thereof. For example, the reference surface may consist of an end of a single strand or a single cable or a single spike. In accordance with another embodiment the reference surface may consist of ends of a plurality of strands. In contrast to a net or a canvas the plurality of strands of a localized surface of this kind is not assembled, in the sense that the strands of the plurality of strands do not form a two-dimensional array.

In one or more embodiments the first surface and/or the first reference surface has a predetermined average surface roughness Ra that is for example greater than 5 μm, for example greater than 10 μm, for example greater than 50 μm. In this way the aggregates of fine particles and/or fine particles that are deposited on the first surface and/or on the reference surface are better retained by the first surface and/or the reference surface, which limits the risk of them being drawn back into the air and therefore leaking to the exterior of the device. One method for measuring said average surface roughness Ra of the surface is for example contact profilometry.

In one or more embodiments said first surface of the at least one first collector comprises a plurality of plates arranged parallel to one another and electrically connected to one another.

In these embodiments the sum of the areas of the plates of said plurality of plates is greater than about 1 m². Moreover, these embodiments can be combined with the embodiments mentioned vide supra in which the first surface and/or the reference surface has or have a predetermined average surface roughness Ra.

In one or more embodiments said reference surface of the at least one first collector comprises a plurality of plates arranged parallel to one another and electrically connected to one another.

In one or more embodiments at least some of the plates of the first surface and some of the plates of the reference surface are arranged in an alternating manner in a first direction of arrangement of the plates. The plates of the first surface and the plates of the reference surface can therefore be arranged in a parallel and alternating manner, at least in part or entirely in the at least one first collector.

In this configuration of parallel plates the air is advantageously slowed minimally, which makes it possible to treat a large volume of air with little consumption of energy, as opposed to prior art aspirators in which the consumption of energy is high in order to compensate the air resistance inherent to the presence of filter cartridges.

The plates of “first surface—reference surface” pairs of plates make it possible to maximize the value of the electric field generated between the first surface and the reference surface. A sufficient distance could nevertheless be looked for in order for the field to remain below a disruptive field, i.e. a field in which arcing may be observed, and to prevent foreign bodies entering the device creating short circuits. In one or more embodiments a distance between a plate of a first surface and a plate of an adjoining reference surface is therefore between about 1 cm and about 50 cm, advantageously between about 1 cm and about 10 cm.

In one or more embodiments the number of plates in the first surface and/or the number of plates in the reference surface is between about 2 and about 100, for example between about 10 and about 50, for example between about 10 and about 25.

In one or more embodiments said first surface is coated with a coating comprising a photocatalyst capable of transforming at least some of the aggregates of fine particles and/or fine particles deposited on said first surface into oxidation products CO₂ and H₂O. The photocatalyst is therefore capable of fragmenting the aggregates of fine particles and/or fine particles deposited on the coating of said first surface and converting them into oxidation products CO₂ and H₂O by a mechanism described for example in [Ref. 5]. In one or more embodiments the coating is present on at least a part of the first surface. In one or more embodiments the photocatalyst is a semiconductor having a wide forbidden gap. In one or more embodiments the photocatalyst is selected in the group including photocatalysts comprising TiO₂, ZnO, CeO₂, ZrO₂, SnO₂, CdS, ZnS and combinations thereof. In one or more embodiments the coating contains titanium oxide TiO₂. Of the various photocatalysts, those including or consisting of TiO₂ have a high oxidizing power, good robustness (in particular good stability over time) and low cost.

In one or more embodiments said coating is the result of application of a solution containing the photocatalyst onto the first surface, as described for example in [Ref. 2], followed by a drying stage during which the coating is formed. Such a solution, when it is applied to the first surface, advantageously makes it possible to stabilize the coating. The solution may contain small quantities of one or more stabilizers, which prevents the coating from crumbling once dry.

In one or more embodiments the reference surface is also coated with a coating comprising a photocatalyst capable of transforming at least some of the aggregates of fine particles and/or fine particles deposited on the reference surface into oxidation products CO₂ and H₂O. In one or more embodiments such a coating is present on at least a part of the reference surface. The coating of the reference surface and the photocatalyst contained in the coating may be identical in every respect or have at least one characteristic in common with, respectively, the coating and the photocatalyst described above with reference to the first surface.

The ionizing device of the air purifier device in accordance with the first aspect of the present description is configured to ionize at least some of the fine particles present in the air, for example by the corona discharge, although this is not limiting on the invention. The device may have its own electric generator. Alternatively the electric generator of at least one first collector configured to apply said first potential to the first surface may equally serve as an electric generator for the ionizing device.

In one or more embodiments the ionizing device comprises a generator of ions, for example a generator of anions or a generator of cations.

As described above the ionizing device comprises a plurality of spikes, a grating and an electric generator configured to apply a predetermined potential relative to the grating to said spikes of the plurality of spikes so as to generate an electric field of at least 100 kV/m between the plurality of spikes and the grating.

In the present description by “spike” is meant a protrusion having a base and a pointed end. The direction of taper of the spike is the direction from the base of the spike toward the pointed end of the spike.

The electric field generated between the plurality of spikes and the grating is reinforced at the end of the spikes because of the “spike effect” described for example in [Ref. 6] and this reinforcement is locally the greater the more pointed the spike, that is to say the smaller the radius of curvature of the end of the spike. Spikes machined for this purpose are available in the industry with radii of curvature of the order of a few micrometers. Another effect stemming directly from the spike effect, called the “corona discharge” and described in detail for example in [Ref. 2] and [Ref. 7], is then liable to be produced at the end of at least one spike. When the electric field is generated between a spike of the plurality of spikes and the grating, the at least one spike will emit cascades of ions by corona discharge and therefore contribute to the ionization of the air entering the air purifier device in the vicinity of the spike. The ions produced in this way are then liable to interact with fine particles in suspension in the incoming air, whether ionized or neutral. Neutral fine particles that come to interact with the ions then in turn acquire an electric charge and can be aggregated into aggregates of fine particles in the agglomeration chamber. Depending on the direction of the field and the sign of the electric charge of said aggregates, said aggregates of fine particles will then be attracted either by the first surface or by the reference surface of the at least one first collector and deposited on the first surface or on the reference surface, respectively. The capacity of the air purifier device to trap fine particles therefore advantageously extends to neutral fine particles.

When the ionizing device is based in particular on a corona discharge, a condition for the corona discharge to be observed is that the spike is electrically conductive. The spike is made of a non-insulating material, for example nickel-plated steel. In one or more embodiments the spikes of the plurality of spikes have a length between 0.1 cm and 10 cm, for example between 0.5 cm and 1.5 cm. In one or more embodiments the spikes of the plurality of spikes have a radius of curvature less than or equal to about 100 μm.

In one or more embodiments the total number of spikes contained in the ionizing device is between 2 and 100, for example between 3 and 50.

In one or more embodiments at least some of the spikes of the ionizing device are arranged parallel to one another and for example configured to be arranged parallel to the direction of an incoming flow of air. In one or more embodiments the plurality of the spikes are arranged so that their direction of taper, that is to say the direction from the base of the spike to the pointed end of the spike, is substantially the same as the direction of the incoming flow of air. In one or more embodiments the spikes are arranged on an insulative, for example wood, support. In one or more embodiments the insulative support is substantially linear, for example a rod. For example, the average distance between two spikes arranged on a substantially linear insulative support is between about 1 cm and about 50 cm, for example about equal to 10 cm. For example, the average density of spikes arranged on a linear support is between about one spike per 10 cm and about one spike per 50 cm. The insulating support is substantially flat, for example a flat grating. For example, the average density of spikes arranged on the insulative support is between about one spike per 10 cm² and about one spike per 200 cm^{2.} In one or more embodiments the spikes of the plurality of spikes are electrically charged to a potential relative to the grating of at least about 1 kV, for example between about 10 kV and about 50 kV. In one or more embodiments the spikes of the plurality of spikes are electrically connected to one another.

The grating is made of a non-insulating material. By grating is meant a two-dimensional array of strands, for example an array of metal strands welded together. In one or more embodiments the grating is meshed (that is to say features substantially regular patterns), the average dimensions of the meshes being for example less than or equal to about 4 mm. In one or more embodiments the diameter of the strands constituting the grating is between about 0.5 mm and about 1.5 mm. In one or more embodiments the grating is electrically connected to ground. In one or more embodiments the grating is arranged upstream from the at least one spike of the ionizing device relative to the incoming flow of air. Alternatively, in one or more embodiments the grating is arranged downstream from the spikes of the plurality of spikes of the ionizing device relative to the incoming flow air.

In one or more embodiments the grating is arranged in a plane substantially perpendicular to an incoming flow of air. The spikes are advantageously arranged substantially perpendicularly to the plane of the grating.

The agglomeration chamber is configured to aggregate at least some of the fine particles ionized by the ionizing device into aggregates of fine particles. The second stage of the device, i.e. the agglomeration chamber, therefore serves as a buffer space between the ionizing device and the at least one first collector. In one or more embodiments a length of the agglomeration chamber in the direction of an incoming flow of air is between 10 cm and 2 m, for example between 20 cm and 1 m, the applicant having demonstrated that such lengths favor the aggregation of fine particles. The phenomenon of aggregation of fine particles that is produced therein is all the more profitable as the small fine particles are generally more hazardous to health that particles of larger size. Further, because of their size and also of their high number of charges, the aggregates of fine particles are easier to capture than non-aggregated fine particles. Without wishing to be limited by any particular theory, the inventors have noted that because of the effect of higher electric fields at the spike end (of the order, for example, of at least 100 kV/m), the fine particles can in fact aggregate with one another to form aggregates of fine particles, for example polymer chains possibly measuring between 2 and 10 microns wide and up to 1 cm long, as depicted in [Ref. 8]. The resulting nanostructured polymers are grouped into pellets capable in turn of trapping small PM in the agglomeration chamber. This is merely one of the possible mechanisms by which the ionized fine particles are aggregated into aggregates of fine particles in the agglomeration chamber, and the inventors do not rule out other mechanisms being employed depending for example on the nature of the fine particles in suspension in the air in accordance with the first aspect. In one or more embodiments the agglomeration chamber comprises a tubular enclosure. This can in effect lead to a more marked reduction of pollution by enabling the generation of electrostatic phenomena that enhance the efficacy of the air purifier device. By “tubular enclosure” is meant a duct formed of a tube having an end. In one or more embodiments the radial section of the tubular envelope varies along its axial direction. In one or more embodiments the radial section of the tubular enclosure is substantially identical along its axial direction, i.e. the tubular enclosure is a cylinder. In one or more embodiments the tubular enclosure is made of a non-insulating material. In one or more embodiments the envelope is electrically connected to ground.

The at least one first collector of the purifier device in accordance with the first aspect is configured to collect at least some of the aggregates of fine particles and/or fine particles, in particular fine particles ionized by the ionizing device.

In one or more embodiments the air purifier device comprise(s) a plurality of collectors. For example, the device may comprise a first collector and at least one second collector. Said at least one second collector is for example configured to be located downstream from the first collector relative to an incoming flow of air so that the incoming air circulates in the plurality of collectors. In one or more embodiments said at least one second collector has features similar to the features cited above with reference to the first collector. The second collector can therefore comprise a second surface that can have the same features cited above with reference to the first surface of the first collector, a second reference surface made of non-insulating material being able to have the same features as mentioned above with reference to the first reference surface of the first collector and a second electric generator. The second electric generator of the second collector can therefore apply to said second surface a second potential between about 5 kV and about 500 KV relative to the second reference surface so as to generate an electric field between said second surface and said second reference surface greater than or equal to about 10 kV/m. In one or more embodiments the electric generator of the second collector is the electric generator of the first collector.

In one or more embodiments the frame comprises:
an inlet chamber arranged upstream from the ionizing device and configured to channel an incoming flow of air toward the interior of the air purifier device, and
an outlet chamber arranged downstream from said at least one collector relative to the incoming flow of air and configured to channel an outgoing flow of air to the exterior of the air purifier device.

In one or more embodiments the frame is in the form of a pipe with variable section. For example, the frame has a pipe shape converging toward the outlet chamber in order to treat a large volume of air at the inlet of the device and potentially to orient the outgoing flow of air. In one or more embodiments at least one voltage controller is configured to vary the electric field generated by the electric generator between said first surface and said first reference surface and therefore to modify the field lines of said electric field. By varying said electric field it is for example possible to change the trajectory of the aggregates of fine particles and/or non-aggregated fine particles, which follow said field lines. It is for example possible to reverse the direction of the electric field which leads for example to attraction of aggregates of fine particles and/or charged fine particles with the opposite sign (compared to the sign of the charge of the aggregates of fine particles and/or fine particles attracted before reversing the direction of the electric field) by said first surface or said first reference surface, said aggregates of fine particles and/or fine particles of opposite sign then coming to be deposited on said first surface or said reference surface. In one or more embodiments the voltage controller is configured to vary the electric field (for example by changing the direction of the electric field) at a predetermined frequency, e.g. in accordance with cycles of about 0.1 second to about 10 seconds. The voltage controller may further represent a solution to cleaning the at least one first collector. For example, by changing the direction of the electric field the aggregates of fine particles and/or fine particles can suddenly be pushed away by the first surface on which they have been collected, are no longer affected by gravity and for example can therefore be aspirated during a device maintenance and/or cleaning operation. In one or more embodiments the device further comprises an airflow control system configured to direct an incoming flow of air toward at least said first surface of the at least one first collector. The airflow control system may equally or alternatively direct surrounding air toward said reference surface of the at least one first collector. In one or more embodiments the airflow control system comprises rolling or foldable tarpaulins. Such tarpaulins are deployed at the periphery of the device to control the flows of surrounding air and for example to orient the direction of the wind.

In one or more embodiments the airflow control system is configured to facilitate the passage of the flow of air between said first surface and said reference surface. The airflow control system comprises for example at least one fan or aerator that aspirates and/or pushes air between the first surface and the reference surface. Said airflow control system therefore makes it possible in particular to ensure a flow of air between said surfaces that is sufficient even in the event of a light wind or no wind. No wind or very slow winds, e.g. at less than 1 meter per second, are generally associated with conditions in which the most severe pollution episodes occur. Said airflow control system can equally make it possible to slow the flow of air, for example in the event of a high wind, so that air passing between the first surface and the reference surface has time to be sufficiently depolluted by the device. In one or more embodiments the at least one fan is arranged at the level of an outlet chamber arranged downstream from the at least one first collector relative to the incoming flow of air. Such an arrangement enables air to be aspirated without disturbing it at the inlet and therefore limits turbulence. Such an arrangement also makes it possible to extract a stable outgoing flow of air to the exterior of the air purifier device and to direct this purified outgoing air toward a target area. This proves advantageous in that if the device is used outdoors a global depollution effect cannot be achieved.

In one or more embodiments the airflow control system comprises at least one deflector configured to orient said incoming flow of air in the air purifier device and/or a flow of air outgoing from the air purifier device. For example, in one or more embodiments the airflow control system comprises at least one deflector arranged at the level of the inlet chamber of the frame and/or at least one deflector arranged at the level of the outlet chamber of the frame. In one or more embodiments the at least one deflector is chosen in the group comprising a fin, a blade, a flap. The at least one deflector may be orientable as a function of the required direction of the incoming flow or of the outgoing flow. For example, the airflow control system may comprise a plurality of vertical blades at the inlet and a plurality of horizontal blades at the outlet and vice versa. Said pluralities of inlet/outlet blades can for example be supported on a plane, e.g. respectively upstream/downstream from the inlet/outlet chamber relative to the incoming/outgoing flow of air. In one or more embodiments the at least one deflector is arranged at least in part outside the inlet/outlet chambers.

In one or more embodiments the electric generator of the at least one first collector, which is configured to apply to the first surface said first potential relative to the reference surface, comprises at least one transformer enabling an output voltage to be generated from an input voltage. In one or more embodiments the transformer is configured to generate an output voltage between 1 kV and 1000 kV, for example between 5 kV and 500 KV, between 5 kV and 100 kV, from an input voltage between 12 V and 300 V, for example 12, 24 or 230 V. In one or more embodiments the electric generator configured to apply to the first surface said first potential relative to the reference surface comprises electricity production means. In one or more embodiments the electricity production means produces electricity autonomously. The electricity production means can for example power the airflow control system and/or the ionizing device. In one or more embodiments the electricity production means renders the air purifier device self-sufficient in energy, which has the advantages of not necessitating any connection to the existing electrical mains and of limiting operating costs. The electricity production means comprise for example an element selected from at least one photovoltaic panel, at least one wind turbine and combinations thereof. The at least one solar panel can be disposed so as to limit the loss of exposure to sunlight of said coating comprising a photocatalyst when the latter coats the first surface and/or the reference surface. Further, the at least one solar panel may be partially or substantially transparent to visible light and/or to UV, for example partially or substantially transparent to blue light and/or UV.

In accordance with a second aspect the description concerns a method of purifying air using an air purifier device in accordance with the first aspect.

The method in accordance with the second aspect comprises:
placing the air purifier device in accordance with the first aspect in and/or under and/or over and/or around an area to be depolluted,
using the ionizing device, ionizing at least some of the fine particles present in the air,
using the agglomeration chamber, aggregating at least some of the fine particles ionized by the ionizing device into aggregates of fine particles,
using the electric generator of the at least one first collector, generating an electric field greater than or equal to about 10 kV/m between said first surface and the reference surface, and
using the at least one first collector, collecting at least some of the aggregates of fine particles.

In one or more embodiments said first surface and said reference surface of the at least one first collector each comprises a plurality of plates arranged parallel to one another and electrically connected to one another, at least some of the plates of the first surface and some of the plates of the reference surface being arranged in an alternating manner in a first arrangement direction, the air purifier device is installed so as to obtain a substantially vertical arrangement of the plates. The substantially vertical arrangement of the plates makes it possible for example to facilitate the alignment of the plates by limiting buckling, which makes it possible to operate at higher voltages without fearing electrical arcing. Further, when the first surface and/or the reference surface is or are coated with a coating comprising the photocatalyst mentioned vide supra, the vertical arrangement of the plates also makes it possible to maximize the absorption of sunlight and therefore the photocatalysis effect. In one or more embodiments the air purifier device is configured to be movable. Thus all or part of the device can be stowed, for example in a shed, and deployed for depollution missions. Alternatively, the device may be deployed permanently at a given location, for example in an area to be depolluted.

In accordance with a third aspect the present description concerns an air purifier assembly comprising a plurality of air purifier devices in accordance with the first aspect in which the air purifier devices are connected, for example mechanically connected, to one another. In one or more embodiments the depollution method in accordance with the second aspect comprises the connection of a plurality of air purifier devices in accordance with the first aspect, e.g. the mechanical interconnection of a plurality of said devices, when said devices are configured for each to be mechanically connected to one or more other devices. A connection of this kind facilitates production of an air purifier assembly of large size, such as an anti-pollution barrier deployed around or along an area to be depolluted of large size, such as a factory or a heavy traffic area such as a high-speed road or a ring road. To this end it may be advantageous for the air purifier devices of the plurality of devices in accordance with the first aspect to be substantially identical or all identical.

In one or more embodiments the device is configured to assume completely or partially the form of urban street furniture. The urban street furniture may for example be of the shade and/or shelter type.

In one or more embodiments the air purifier device in accordance with the first aspect is configured to take the form of a shade with a length between 1 and 20 m, for example between 1 and 10 m, a width between 1 and 10 m, for example between 1 and 5 m, comprising a central supporting pylon having a height between 1 and 10 m.

In one or more embodiments an air purifier device in accordance with the first aspect or the air purifier assembly in accordance with the third aspect is configured partly to take the form of urban street furniture of bus shelter or kiosk type. The bus shelter may offer one or more of the following advantages: the presence of a mechanical support, the possibility of connection to an electrical mains, protection against wind. The volume under the bus shelter is protected from the wind and may efficaciously benefit from the depollution provided by the device. The air purifier device may for example be installed on the roof of a bus shelter and in one or more embodiments comprise an airflow control system as described hereinabove enabling aspiration of air from the exterior and ventilation of purified air to users.

In one or more embodiments the air purifier device in accordance with the first aspect comprises at least one fixing means, e.g. a plurality of fixing lugs, configured for mechanically connecting the air purifier device to a vehicle. For example, the at least one fixing means may be configured to connect the air purifier device mechanically to the roof of a vehicle, e.g. the roof of a bus. Alternatively, the air purifier device may be installed under the frame of a vehicle, for example an electric vehicle.

In one or more embodiments the air purifier device has a volume contained within a rectangular parallelepiped with a length between about 190 cm and about 250 cm, a width between about 80 and about 120 cm, and a height between about 10 and 200 cm.

### BRIEF DESCRIPTION OF THE FIGURES

Other advantages and features of the invention will become apparent on reading the description illustrated by the following figures:

FIG. 1A, a schematic viewed from above of one example of an air purifier device in accordance with the present description.

FIG. 1B, a schematic perspective view of an example of a device similar to that depicted in FIG. 1A.

FIG. 2A, a schematic front view of a bus to the roof of which are mechanically connected four examples of devices in accordance with the present description.

FIG. 2B, a schematic side view of the bus depicted in FIG. 2A.

FIG. 2C, a schematic view from above of the bus depicted in FIGS. 2A and 2B.

FIG. 2D, a schematic side view from the left side of the bus depicted in FIGS. 2A-2C.

FIG. 3A, a schematic perspective view of an assembly of other examples of devices in accordance with the present description forming an anti-pollution barrier.

FIG. 3B, a schematic perspective view of a device configured to be connected to one or more other devices to form the anti-pollution barrier depicted in FIG. 3A.

FIG. 3C, a schematic longitudinal view of the view depicted in FIG. 3B.

FIG. 4, a schematic transverse view of a bus shelter on the roof of which another example of a device in accordance with the present description is deployed.

### DETAILED DESCRIPTION OF THE INVENTION

In the figures elements are not represented to scale for improved legibility.

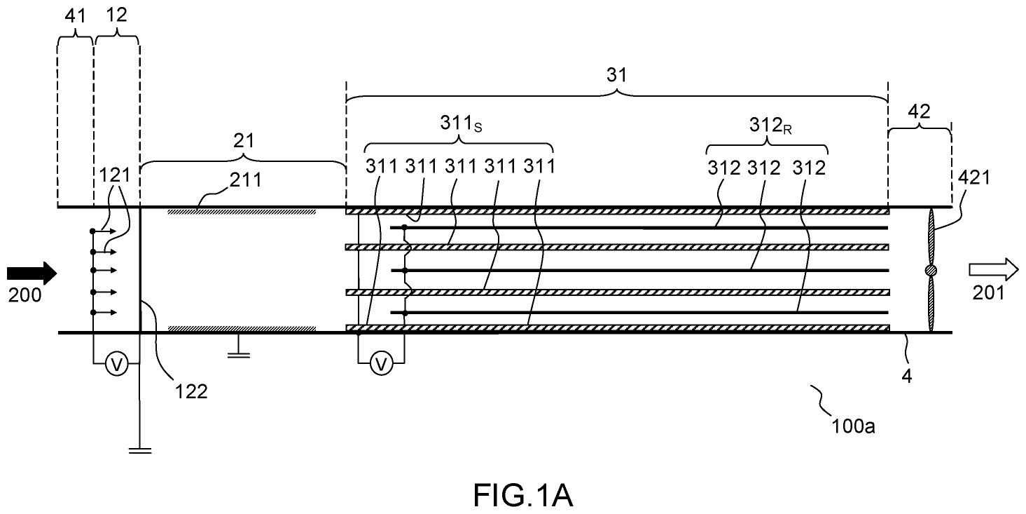

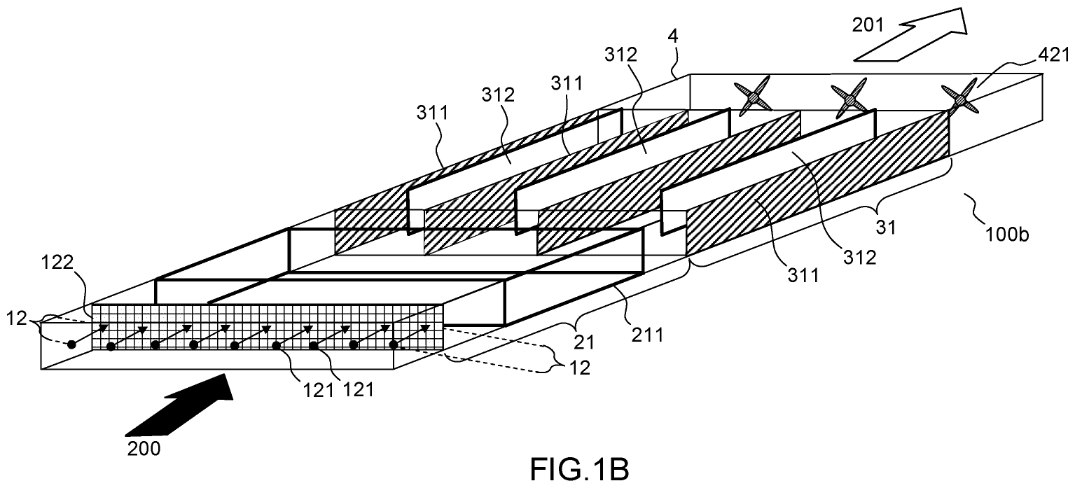

A view from above of a first example of an air purifier device 100a is depicted in FIG. 1A. FIG. 1B is a perspective view of another example of the device 100b.

As depicted in FIGS. 1A-1B, the device 100a, 100b for purifying an incoming flow of air 200 comprises at least one first collector 31. In other embodiments of the device (not represented) the device may comprise a plurality of collectors arranged one behind the other. The collector 31 comprises a non-insulating material first surface 311_{S} with a size greater than about 1 m² and a non-insulating reference surface 312_{R}. The collector 31 further comprises an electric generator configured to apply to said first surface 311s a first potential between about 5 kV and about 500 kV relative to said reference surface 312_{R} so as to generate an electric field between said first surface 311s and said reference surface 312_{R} greater than or equal to about 10 kV/m.

The air purifier device 100a, 100b further comprises an ionizing device 12 configured to ionize some of the fine particles present in the incoming air 200 and an agglomeration chamber 21 configured to aggregate at least some of the fine particles ionized by the ionizing device 12 into aggregates of fine particles. Said collector 31 is for its part configured to collect at least some of the aggregates of fine particles. Non-aggregated particles may also be collected.

As depicted in FIGS. 1A-1B the device comprises a frame 4 configured to enclose at least the ionizing device 12, the agglomeration chamber 21 and the at least one first collector 31. The frame 4 may be made of an insulating material or a non-insulating material. The frame may for example be made of a non-insulating material and electrically connected to ground, for safety.

The air purifier device 100a, 100b may for example be configured to extend in an area to be depolluted.

The ionizing device 12 comprises a plurality of spikes 121, for example between 2 and 100 spikes emitting ions, and a grating 122. Said electrical generator of at the least one first collector may equally serve as an electric generator for the ionizing device and may be configured to apply to said spikes of the plurality of spikes 121 a predetermined potential relative to the grating so as to generate an electric field between the plurality of spikes 121 and the grating 122 of at least about 100 kV/m. This field value is sufficient to ionize at least some of the fine particles present in the incoming polluted air 200. In some embodiments of the air purifier device the ionizing device comprises its own electric generator.

The spikes 121 are for example made of a non-insulating material, for example nickel-plated steel. For example, the spikes have a length between about 0.1 cm and about 10 cm and for example have an end with a radius of curvature less than or equal to about 100 μm. Further, as FIGS. 1A-1B show the spikes 121 of the ionizing device 12 may be arranged parallel to one another and for example configured to be arranged parallel to a direction of the incoming flow of air 200.

Further, the spikes 121 may be arranged so that their direction of taper, that is to say the direction from the base of the spike to the pointed end of the spike, is the same as the direction of the incoming flow of air 200 (i.e. from the exterior to the interior of the device 100a, as represented by the black arrow 200 in FIG. 1A). In certain embodiments, either at least some of or all of said spikes are arranged so that their directions of taper are reversed relative to the direction of the incoming flow of air.

As depicted in FIG. 1A, the spikes 121 may be electrically interconnected. The spikes 121 may for example be arranged on an insulating support, for example a wooden rod.

The grating 122 is for example made of non-insulating material. For example, the grating 122 consists of a meshed array of metal strands welded together. The average dimension of the meshes is for example less than or equal to about 4 mm. The diameter of the strands constituting the grating 122 is for example about 1 mm. The grating is electrically connected to ground for example. As depicted in FIGS. 1A and 1B the grating may further be arranged downstream from the spikes 121 of the ionizing device 12 relative to the incoming flow of air 200. Further, the grating 122 may be arranged in a plane perpendicular to the incoming flow of air 200. The spikes 121 are for example arranged perpendicularly to the plane of the grating 122, as depicted in FIGS. 1A and 1B.

The ionizing device is for example based on the corona discharge.

The agglomeration chamber 21 configured to aggregate at least some of the fine particles ionized by the ionizing device 12 into aggregates of fine particles serves as a buffer space between the ionizing device 12 and the collector 31.

As depicted in FIGS. 1A and 1B the agglomeration chamber 21 may comprise a tubular enclosure 211. Such an arrangement can enable greater reduction of pollution by making it possible to generate electrostatic phenomena to enhance the efficacy of the purifier device. The tubular enclosure 211 is for example made of non-insulating material. The enclosure 211 is for example made of untreated aluminum or another non-insulating material. The tubular enclosure 211 may for example be electrically connected to ground.

As depicted in FIGS. 1A and 1B the first surface 311s of the collector 31 may consist of a plurality of plates 311 arranged parallel to one another and for example electrically interconnected. The reference surface 312_{R} of the collector 31 may equally consist of a plurality of plates 312 arranged parallel to one another and for example electrically interconnected. In FIGS. 1A and 1B only four plates 311 are represented for the first surface 311s and only three plates 312 are represented for the reference surface 312_{R}. Of course, the number of plates 311 and/or 312 may vary depending on the embodiment and is obviously not limited to that of the air purifier device 100a, 100b depicted in FIGS. 1A and 1B. For example, the number of plates may be greater, for example between about 10 and about 25.

As depicted in FIGS. 1A and 1B, the plates 312 of the reference surface may be interleaved between the plates 311 of the first surface. The plates 311 of the first surface and the plates 312 of the reference surface may be arranged in an alternating manner in a first direction of arrangement of the plates.

In a configuration with parallel plates air is advantageously slowed minimally, which makes it possible to treat a larger volume of air with little consumption of energy. Further, the closeness of the plates of the “first surface-reference surface” pairs of plates (311, 312) makes it possible to maximize the value of the electric field generated between the first surface and the reference surface but to remain at a value below the disruptive field, i.e. the field at which arcing might be observed.

As depicted in FIGS. 1A-1B the distance between the “first surface—reference surface” plates (311, 312) may be substantially constant in said first direction of arrangement of the plates. The distance may for example be about at least 1 cm which for example makes it possible to prevent foreign bodies entering into the device creating short circuits.

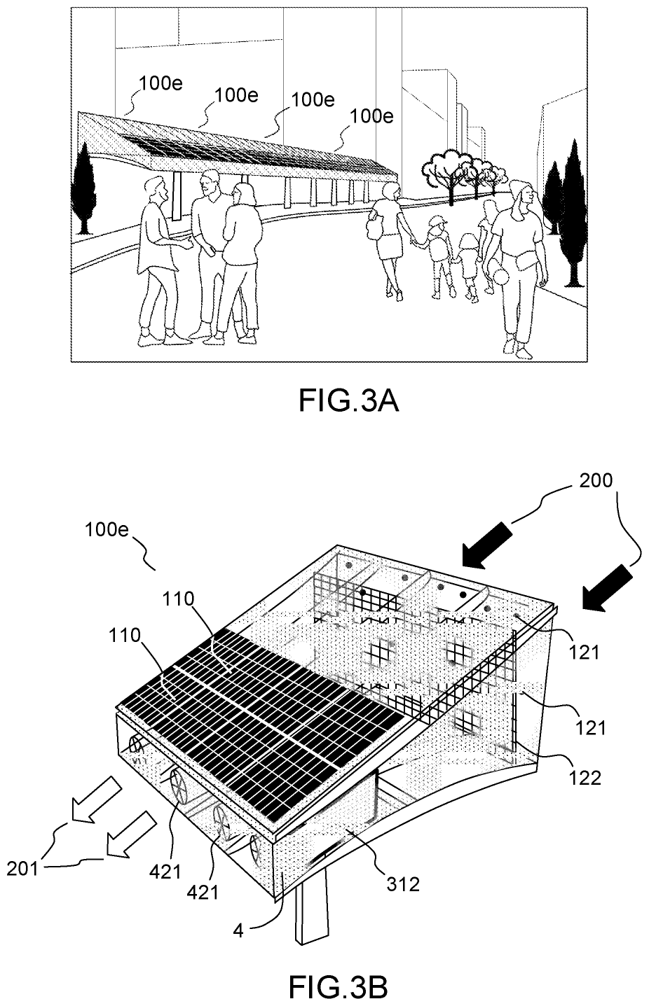

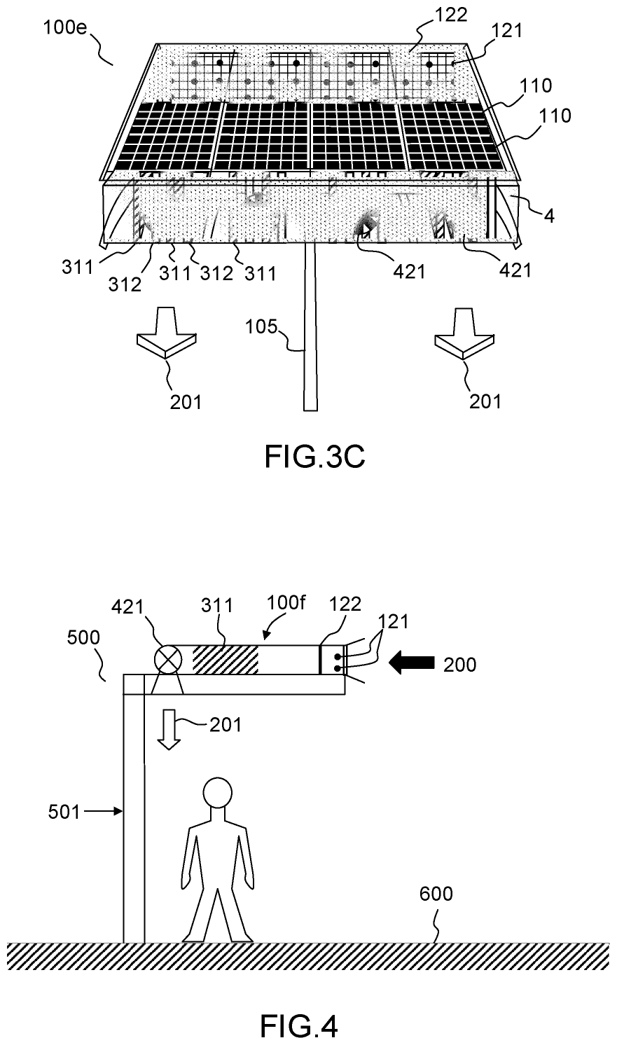

In some embodiments only some of the plates 311 of the first surface and some of the plates 312 of the reference surface are arranged in an alternating manner (e.g. “311, 312, 311, 312”). Similarly, in some embodiments the distance between the “first surface—reference surface” plates (311, 312) is not constant in said first direction of arrangement of the plates, as depicted for example in FIG. 3C (see below for more details).

The first surface 311s and/or the reference surface 312_{R} may have a predetermined surface roughness Ra. For example Ra is greater than 5 μm, for example greater than 30 μm, for example greater than 50 μm.

The frame 4 may for example comprise an inlet chamber 41 arranged upstream from the ionizing device 12 and configured to channel an incoming flow of air 200 to the interior of the air purifier device 100a, 100b. The frame may for example comprise an outlet chamber 42 arranged downstream from the at least one first collector relative to the incoming flow of air and configured to channel an outgoing flow of air 201 to the exterior of the air purifier device 100a, 100b.

The device 100a, 100b may for example further comprise an airflow control system configured to direct the incoming flow of air 200 to at least the first surface 311s of the collector 31. The airflow control system may for example comprise at least one fan 421. The airflow control system is configured to facilitate the passage of the flow of air between said first surface 311s and said reference surface 312_{R}. The at least one fan 421 aspirates and/or forces air between said first surface 311s and said reference surface 312_{R}, e.g. between the plates 311, 312 of the first surface and of the reference surface, and makes it possible to assure a flowrate of air between said surfaces that is sufficient even in the event of a slow wind or no wind at all.

The at least one fan 421 is for example arranged at the level of an outlet chamber 42 arranged downstream from the at least one collector 31 relative to the incoming flow of air 200. An arrangement of this kind enables air 200 to be aspirated without disturbing it at the inlet and so limits turbulence. An arrangement of this kind also makes it possible to extract a stable outgoing flow of air 201 from the air purifier device, and for example to direct that outgoing purified air 201 to a target area. This can prove advantageous if, when the device is used outdoors, a global depollution effect cannot be achieved.

The electric generator of the collector 31 is represented by the symbol “V” in FIG. 1A. The electric generator of the collector 31, configured to apply said first potential to the first surface, may for example also serve as an electric generator for the ionizing device 12 in order to generate said electric field between the plurality of spikes 121 and the grating 122. The electric generator may for example comprise a transformer for generating an output voltage, for example between 1 kV and 1000 kV, for example between 5 kV and 500 KV, for example between 5 kV and 100 kV, from an input voltage between 12 V and 300 V, for example 12 V, 24 V or 230 V. The generator may for example comprise a means for production of electricity (not depicted) capable for example of supplying with electricity the ionizing device 12 and/or the at least one fan 421.

Further, the first surface 311s and/or the reference surface 312_{R} may for example be partially or completely coated with a coating (not depicted) comprising a photocatalyst capable of transforming at least some of the aggregates of fine particles and/or fine particles deposited on said surfaces into oxidation products CO₂ and H₂O. The photocatalyst may for example comprise titanium dioxide TiO₂.

The aggregates of fine particles and/or fine particles trapped by the collector 31 because of the influence of the electric field generated between the first surface 311s and the reference service 312_{R} can therefore be successively transformed into inoffensive oxidation products.

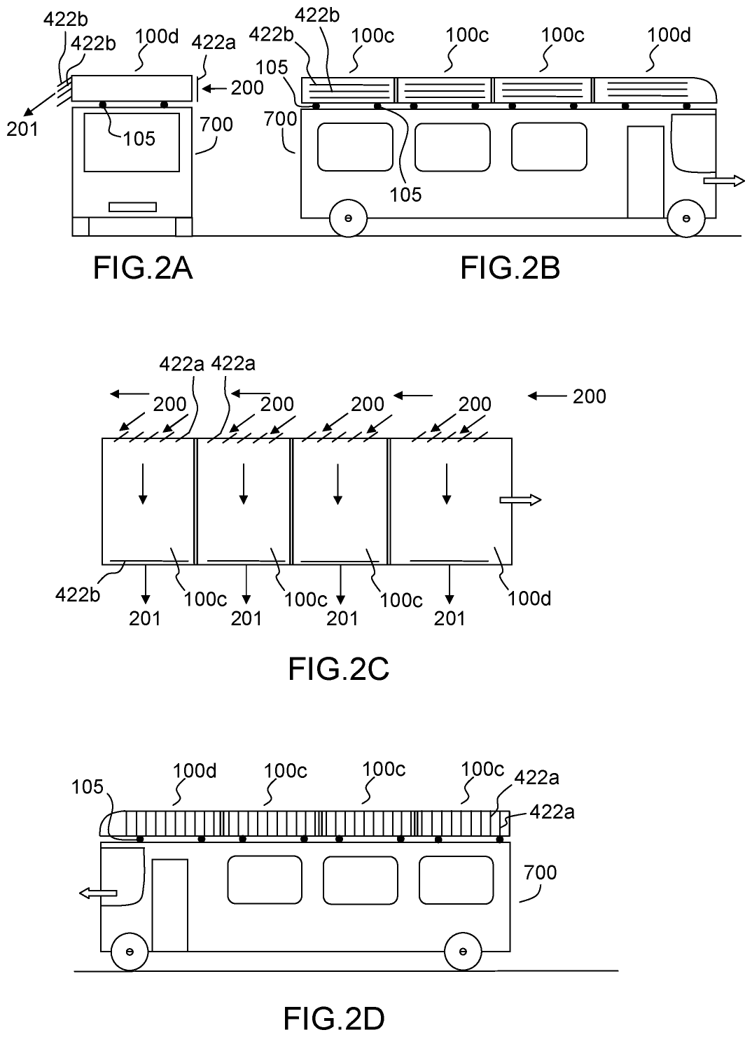

Other examples of air purifier devices 100c, 100d in accordance with the first aspect of the present description and for example similar to those described with reference to FIGS. 1A-1B are depicted in FIGS. 2A-2D. Each of the devices 100c, 100d comprises a frame configured to enclose at least the ionizing device, the agglomeration chamber and at the least one first collector. A vehicle is represented in FIGS. 2A-2D, i.e. a bus 700 to the roof of which three devices 100c and one device 100d are connected, for example by fixing means 105, connected for example to the frame of each air purifier device. As FIGS. 2B and 2D show, the device 100d situated at the front of the bus can have a frame with a shape tapered toward the front conferring on it an improved capacity to penetrate the air. The four devices 100c, 100d are for example mechanically connected to one another via e.g. welds, spots of glue, bolts, screws, nuts. Of course, a different number of identical or different air purifiers may be arranged on a vehicle.

Each device 100c, 100d may for example comprise means for fixing it to the roof of the bus, namely a plurality of fixing lugs 105, for example. The fixing lugs are for example distributed in the vicinity of the corners and/or the sides of the device 100c, 100d. The fixing means is for example configured to connect the device 100c, 100d directly to the roof of the bus 700. A connection to a roof rack and/or to reinforcing ribs mounted on the roof of the bus may equally be envisaged in some embodiments, for example a connection by one or more clamps. The air purifier device 100c may be contained within a volume having a shape adapted to the shape of the roof of the vehicle, for example substantially the shape of a rectangular parallelepiped, even if other shapes can be envisaged, such as for example the shape of the tapered device 100d. The rectangular parallelepiped may for example have the following dimensions: a length between 190 cm and 250 cm, a width between 80 cm et 120 cm and a height between 10 cm and 200 cm. Said length may for example be oriented along the width of the bus. Such dimensions enable adaptation to the permitted sizes of buses in France/Europe.

The electric generator of the at least one first collector (not represented) of each device 100c, 100d may for example comprise an electricity production means that is specific to it and/or connected to the battery of the vehicle.

Such an assembly of air purifier devices installed on the roof of the vehicle, e.g. a truck, a coach, an automobile or a bus as depicted for example in FIGS. 2A-2D, has multiple advantages, in particular in urban centers where PM thresholds are regularly exceeded. For example, the bus 700 fitted with an assembly of air purifier devices can circulate through an urban center on polluted routes capturing polluted air as close as possible to the emission of pollution. Pollution is denser in the vicinity of its source/emitter and newer, which makes it possible to trap it before it is dispersed and/or before the occurrence of reactions creating secondary products. Further, as depicted in FIGS. 2A and 2D in particular, for a bus 700 driven for example on the right, the air purifier devices mounted on its roof can for example capture polluted air 200 coming from the road and evacuate purified air 201 toward the sidewalk, where pedestrians can have the direct benefit of it.

Such an orientation of the incoming and outgoing flows of air of each device may be facilitated by the presence of at least one deflector configured to orient said flow of air in the air purifier device and/or said flow of air leaving the air purifier device.

Each air purifier device may for example comprise an airflow control system comprising at least one deflector 422a at the inlet of the device and/or at least one deflector 422b at the outlet of the device.

The input deflectors 422a may be blades vertical relative to the roof of the bus, as FIG. 2A shows. FIG. 2C further shows that the inlet deflectors 422a of each device may be oriented at an angle of about 45° for example relative to the left side of the bus. Further, FIG. 2C and FIG. 2A respectively show that the outlet deflectors 422b may be horizontal blades and may for example be oriented, for example at an angle of about 30° relative to the roof of the bus, to target the sidewalk and/or pedestrians present on the right side of the bus.

Said pluralities of inlet/outlet blades 422a, 422b may for example be supported on a flat grating (not represented in the figures), e.g. respectively upstream/downstream from the inlet/outlet chamber relative to the incoming flow of air 200/outgoing flow of air 201. In the non-limiting example depicted in FIGS. 2A-2D the frame of the device 100c, 100d comprises an inlet chamber and an outlet chamber inside which such flat gratings are provided.

FIGS. 2A and 2C are respectively a view from the front and from above of the bus 700 and show the action of the inlet deflectors 422a and the outlet deflectors 422b on the incoming flow of polluted air 200 and the outgoing flow of purified air 201. The bus is travelling for example forwards and on the right side of the road, which generates an incoming entry of polluted air 200 facilitated by the inlet deflectors 422a and targeted evacuation of outgoing purified air 201 by the outlet deflectors 422b.

The airflow control system of the device 100c, 100d may for example comprise at least one fan (not represented in the figures), arranged for example at the outlet of the device, for example in the outlet chamber of the frame. The device is then capable of purifying air effectively even when the bus is stationary and/or stuck in a traffic jam.

Air inlets that may be present on the bus 700 may for example be connected to the outlet of the device 100c, 100d in order for example to renew the air in the bus.

Further, the bus may for example contain a system for cooling the purified air 201 in order for the purified air 201 evacuated by the device 100c, 100d to remain longer near the ground, so as to constitute a pure air mattress, for example between the road and buildings. Further, maintenance and cleaning of the device 100c, 100d, in particular of the at the least one first collector, may for example be added to the maintenance of the bus.

Further, when the first surface and/or the reference surface is coated with a coating comprising a photocatalyst capable of transforming at least some of the aggregates of fine particles and/or fine particles respectively deposited on said first surface or said reference surface into oxidation products CO₂ and H₂O the frame may for example advantageously be partially or substantially transparent to visible light and/or to UV, for example partially or substantially transparent to blue light and/or to UV.

Further, when the first surface and/or the reference surface of the at least one first collector comprise(s) a plurality of plates arranged parallel to one another, it is advantageous for them to be arranged in a “vertical” manner, that is to say parallel to the planes of FIGS. 2B and 2C, in order to maximize the absorption of sunlight and therefore the effect of the photocatalyst. Vertical arrangement of the plates also facilitates alignment of the plates, limiting buckling, which enables the air purifier device to function at high voltages without fearing electrical arcs. Further, when the plates are arranged vertically it may prove advantageous for the upper part of the frame to be removable at least in part, for example via at least one sliding connection, in order to facilitate cleaning and/or replacement of the plates. FIG. 3A depicts an air purifier assembly comprising a plurality of air purifier devices 100e in accordance with another embodiment of the present description. The devices 100e are for example, but not necessarily, substantially identical.

In this particular example the assembly is configured to form an anti-pollution barrier, for example with a lengthwise dimension greater than about 40 m. One such barrier is depicted in FIG. 3A and comprises a plurality of mechanically interconnected devices 100e, interconnected for example by welds, spots of glue, bolts, screws, nuts. The barrier is for example deployed along a high-speed road (not represented) and therefore protects places where pedestrians walk from pollution.

An example of an air purifier device 100e suitable for an assembly of the type depicted in FIG. 3A is represented in more detail in FIGS. 3B and 3C.

Each air purifier device 100e comprises a frame 4 configured to enclose at least the ionizing device, the agglomeration chamber and the at least one first collector. As FIGS. 3B and 3C show, the ionizing device comprises a plurality of spikes 121 and a grating 122. An electric field of at least 100 kV/m is generated between the plurality of spikes 121 and the grating 122.

The device 100e may for example comprise only one collector. The first surface of the collector may comprise a plurality of plates 311 arranged parallel to one another and electrically connected to one another. Likewise, the reference surface of the collector may comprise a plurality of plates 312 arranged parallel to one another and electrically connected to one another. For example, all of the plates 311 of the first surface and the plates 312 of the reference surface are arranged in an alternating manner (311, 312, 311, 312, . . . ). The plates are for example “vertical”, that is to say substantially perpendicular to the ground and to the plane of FIG. 3C. As described in detail above, this configuration makes it possible for example, among other advantages, to minimize the air resistance of the device, to optimize the amount of sunshine to which the plates are exposed and to limit buckling of the plates. The device 100e may advantageously take the form of shade type urban street furniture. The device 100e may not need to be configured to be mobile, but to remain permanently in an urban area in order to purify the air therein. As depicted in FIGS. 3A-3C the device 100c may for example form a shade comprising a central supporting pylon 105 having for example a height between 1 and 10 m, e.g. a height of about 2 m. Further, the frame 4 may for example have dimensions between about 1 m and about 5 m in width and between about 1 m and about 10 m in length, e.g. a width of about 3 m and a length of about 5 m. Thus an assembly of eight devices 5 meters long enables production of an air-pollution barrier 40 meters long. The frame is for example slightly flared on the side facing the high-speed road. In this way the frame can take the form of a pipe converging toward the outlet of the air purifier device 100c. Polluted air 200 from the high-speed road is therefore commensurately channeled to the device in order to treat a large volume of air at the inlet of the device and the outgoing flow of air 201 may advantageously be oriented toward the pedestrians.

The polluted air 200 coming from the high-speed road enters the device. The outgoing air 201 leaves the device 100c on the pedestrian side as purified air. The device 100e may comprise an airflow control system comprising for example a plurality of fans 421.

Each fan 421 aspirates and/or forces air between the first surface and the reference surface of the collector. The fans 421 advantageously make it possible to ensure a sufficient flow of air even in the event of a slow wind or no wind. In the event of a strong wind the fans 421 also make it possible to reduce the speed at which the air passes between said surfaces so that said air has time to be sufficiently depolluted by the device 100c.

In some embodiments the fact that the first surface and the reference surface both consist of substantially plane plates generates a low resistance to wind and to air circulating between said surfaces of the device 100c, which enables the fans 421 of the airflow control system to consume relatively little energy.

The electric generator of the collector configured to apply to the first surface said first potential relative to the reference surface may further comprise a means for production of electricity, for example photovoltaic panels 110 as depicted in FIGS. 3A to 3C. The photovoltaic panels 110 may for example supply at least one fan 421 with electric current and/or power the ionizing device. The photovoltaic panels 110 can for example render the device 100e self-sufficient in energy, which offers the advantage of not necessitating connection to existing electric mains and limiting the operating costs of the device. Further, the frame 4 of the device 100e may comprise a protective grating enclosing at least the ionizing device, the agglomeration chamber and the collector, as depicted in FIGS. 3A-3C.

Another example of an air purifier device is depicted in FIG. 4. FIG. 4 is a cross-sectional view of urban street furniture fixed to the ground 600, i.e. a bus shelter 500 comprising on its roof an air purifier device 100f.

The bus shelter 500 may for example offer the following advantages: the presence of a mechanical support, the possibility of connection to an electrical mains, protection 501 against wind. Further, as depicted in FIG. 4 the device 100f may comprise an airflow control system comprising for example at least one fan 421 enabling aspiration of air 200 from the outside and ventilation for users by means of purified air 201.

FIG. 4, which depicts a cross section of the bus shelter 500, further shows that the device 100f may for example feature a “vertical” arrangement of the plates forming the first surface and the reference surface of the collector and/or a taper of the frame at the inlet, with the aforementioned advantages.

The criteria for choosing the location of an air purifier device in accordance with the first aspect of the present description may for example in a non-limiting manner comprise the availability of a site of large area, the proximity of a population, which accounts for the benefit of air pollution, or the availability of an electrical power supply, for example the availability of a connection of the device to the electric mains, to the data network of the town or of the commune containing said site.

Although described through a certain number of detailed embodiments, the device comprises variants, modifications and improvements that will be obvious to the person skilled in the art, it being understood that these variants, modifications and improvements must fall within the scope of the invention as defined by the following claims.

### REFERENCES

Ref. 1: https://envinitygroup.com/Ref.

Ref. 2: Granted patent FR 3075665

Ref. 3: US 2013/025449 A1

Ref. 4: US 2020/376498

Ref. 5: [Chem. Rev., 2014, 114 (19), pp 9919-9986, «Understanding TiO₂ Photocatalysis: Mechanisms and Materials»].

Ref. 6: https://fr.wikipedia.org/wiki/Effet_de_pointe

Ref. 7: https://fr.wikipedia.org/wiki/Effet_corona

Ref. 8: [Plasma Chem Plasma Process, 2017, 37, pp 1069-1090 «Synthesis of Carbon—Metal Multi-Strand Nanocomposites by Discharges in Heptane Between Two Metallic Electrodes»]

1. An air purifier device comprising:
at least one first collector comprising:
a non-insulating material first surface of size greater than 1 m²,
a non-insulating material first reference surface, and
a first electric generator configured to apply to the first surface a first potential relative to the first reference surface between 5 kV and 500 kV so as to generate an electric field between the first surface and the first reference surface greater than or equal to 10 kV/m;
an ionizing device configured to ionize some of the fine particles present in the air;
an agglomeration chamber configured to aggregate at least some of the fine particles ionized by the ionizing device into aggregates of fine particles,
wherein the at least one first collector is configured to collect at least some of the aggregates of fine particles; and
a frame configured to enclose at least the ionizing device, the agglomeration chamber and the at least one first collector,
wherein the ionizing device comprises a plurality of spikes, a grating and an electric generator configured to apply to the spikes of the plurality of spikes a predetermined potential relative to the grating so as to generate an electric field of at least 100 kV/m between the plurality of spikes and the grating.

2. The air purifier device as claimed in claim 1, wherein the agglomeration chamber comprises a tubular non-insulating material enclosure.

3. The air purifier device as claimed in claim 1, further comprising at least one second collector, the at least one second collector comprising:
a non-insulating material second surface of size greater than 1 m²,
a non-insulating material second reference surface, and
a second electric generator configured to apply to the second surface a second potential relative to the second reference surface between 5 kV and 500 kV to generate an electric field greater than or equal to 10 kV/m between the second surface and the second reference surface,
wherein the at least one second collector is configured to be located downstream from the first collector relative to an incoming flow of air.

4. The air purifier device as claimed in claim 1, any one of the preceding claims,
wherein the first surface of the at least one first collector comprises a plurality of plates arranged parallel to one another and electrically connected to one another,
wherein the first reference surface of the at least one first collector comprises a plurality of plates arranged parallel to one another and electrically connected to one another, and
wherein at least some of the plates of the first surface and of the plates of the first reference surface are arranged in an alternating manner in a first arrangement direction.

5. The air purifier device as claimed in claim 1, wherein the frame is in the form of a pipe with variable section.

6. The air purifier device as claimed in claim 1, wherein the frame comprises:
an inlet chamber arranged upstream from the ionizing device and configured to channel an incoming flow of air to the interior of the air purifier device, and
an outlet chamber arranged downstream from the at least one first collector relative to the incoming flow of air and configured to channel an outgoing flow of air to the exterior of the air purifier device.

7. The air purifier device as claimed in claim 1,
wherein the first surface or the first reference surface of the at least one first collector is or are coated with a coating comprising a photocatalyst capable of transforming at least some of the aggregates of fine particles or fine particles respectively deposited on the first surface or the first reference surface into oxidation products CO₂ and H₂O.

8. The air purifier device as claimed in claim 1,
further comprising an airflow control system configured to direct an incoming flow of air to the first surface of the at least one first collector.

9. The air purifier device as claimed in claim 8, wherein the airflow control system comprises at least one fan.

10. The air purifier device as claimed in claim 9, wherein the at least one fan is arranged at the level of an outlet chamber arranged downstream from the at least one first collector relative to the incoming flow of air.

11. The air purifier device as claimed in claim 8, wherein the airflow control system comprises at least one deflector configured to orient the incoming flow of air or an outgoing flow of air.

12. The air purifier device as claimed in claim 1, configured to take completely or partially the form of urban street furniture of shade or shelter type.

13. The air purifier device as claimed in claim 1, further comprising at least one fixing means configured to mechanically connect the air purifier device to a vehicle.

14. An air purifier assembly comprising a plurality of air purifier devices as claimed in claim 1, wherein the air purifier devices are mechanically connected to one another.

15. A method of purifying air using an air purifier device,
the method comprising:
placing the air purifier device in proximity to an area to be depolluted;
ionizing, by an ionizing device comprised in the air purifier device, at least some of the fine particles present in the air;
aggregating, by an agglomeration chamber comprised in the air purifier device, at least some of the fine particles ionized by the ionizing device into aggregates of fine particles;
generating, by an electric generator of the at least one first collector comprised in the air purifier device, an electric field greater than or equal to 10 kV/m between a first surface and a reference surface comprised on the first collector; and
collecting, by the at least one first collector, at least some of the aggregates of fine particles.
